(19) United States
(12) Patent Application Publication
(10) Pub. No.: US 2010/0142401 A1
(43) Pub. Date: Jun. 10, 2010

(54) Methods, Systems, And Computer Program Products For Determining A Network Identifier Of A Node Providing A Type Of Service For A Geospatial Region

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/328,059

(22) Filed: Dec. 4, 2008

(51) Int. Cl. H04L 12/28

(52) U.S. Cl. 370/254

(57) ABSTRACT

Methods and systems are described for determining a network identifier of a node providing a type of service for a geospatial region. In one aspect, input indicating a query region and a type of service is received. A query message is generated, including information identifying the type of service and the region, and sent for delivery to a network directory service representing a domain having a domain region at least partially including the query region. A response message from the network directory service is received including a network identifier of a node, in the domain, providing the identified type of service.

### RELATED APPLICATIONS

This application is related to the following commonly owned U.S. Patent Applications, the entire disclosure of each being incorporated by reference herein:

application Ser. No. 11/962,285 (Attorney Docket No I509/US) filed on Dec. 21, 2007, entitled “Methods And Systems For Sending Information To A Zone Included In An Internet Network”;

application Ser. No. 12/170,281 (Attorney Docket No I522/US) filed on Jul. 10, 2008, entitled “Methods And Systems For Resolving A Geospatial Query Region To A Network Identifier”;

application Ser. No. 12/170,829 (Attorney Docket No I523/US) filed on Jul. 10, 2008, entitled “Methods And Systems For Resolving Location Information To A Network Identifier”;

application Ser. No. 12/170,833 (Attorney Docket No I524/US) filed on Jul. 10, 2008, entitled “Methods And Systems For Resolving A Query Region To A Network Identifier”;

application Ser. No. ______ (Attorney Docket No I496/US) filed on ______, entitled “Methods, Systems, And Computer Program Products For Browsing Using A Geospatial Map Metaphor”;

application Ser. No. ______ (Attorney Docket No I508/US) filed on ______, entitled “Methods, Systems, And Computer Program Products For Associating Resources Of A First Geospace With A Second Geospace”;

application Ser. No. ______ (Attorney Docket No I515/US) filed on ______, entitled “Methods, Systems, And Computer Program Products For Harmonizing A Geospatial Domain Space With A Non-Geospatial Domain Space”;

application Ser. No. ______ (Attorney Docket No I516/US) filed on ______, entitled “Methods, Systems, And Computer Program Products For Accessing A Resource Based On Metadata Associated With A Location On A Map”; and

application Ser. No. ______ (Attorney Docket No I534/US) filed on ______, entitled “Methods, Systems, And Computer Program Products For Accessing A Resource Having A Network Address Associated With A Location On A Map.”

### BACKGROUND

In the current domain name system (DNS), a query identifying a geospatial region for returning a network identifier of a node associated with the region is not supported. In the current DNS, performing such a query is impractical. Geospatial region information is associated with a node in the DNS currently by a LOC record as defined in RFC 1876 entitled “A Means for Expressing Location Information in the Domain Name System”, C. Davis, P. Vixie, T. Goodwin, et al. January 1996. LOC records are managed by a DNS server responsible for a DNS naming domain, such as example.com. A LOC record allows an IP address to be resolved to a location/region. A DNS server responsible for a specified domain can include LOC records identifying locations in any number of distinct geospatial regions. LOC records for any given specified region are typically distributed across the DNS, and thus can be stored on any number of DNS servers. There is no DNS server that is authoritative or responsible for a specified geospatial region.

Further, applications, such as browsers, often need to know more than a host network address. For example, a browser requires a Uniform Resource Locator (URL) for identifying a service accessed via a network address of a node hosting the service. Currently DNS provides service records for locating services of various types for an identified non-geospatial domain. A DNS naming domain can span more than one subnet and can span multiple, disjoint geospatial regions. There is no standard way of locating a service associated with a specified geospatial region.

### SUMMARY

Accordingly, there exists a need for methods, systems, and computer program products for determining a network identifier of a node providing a type of service for a geospatial region.

Methods and systems are described for determining a network identifier of a node providing a type of service for a geospatial region. In one aspect, input indicating a geospatial query region and a type of service is received. A query message is generated, including information identifying the type of service and the query region, and sent for delivery to a network directory service representing a domain having a domain region at least partially including the query region. A response message from the network directory service is received including a network identifier of a node, in the domain, providing the identified type of service.

In another aspect, the network directory service receives the query message and a determination is made whether the network directory service represents a domain having a domain region at least partially including the geospatial query region. Responsive to determining that the network directory service represents the domain, a network identifier of a node, in the domain, providing the identified type of service is determined. A response message including the network identifier is generated and sent in response to the query message.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a flow diagram illustrating a method for determining a network identifier of a node providing a type of service for a geospatial region according to an aspect of the subject matter described herein;

FIG. 2 is a block diagram illustrating components for determining a network identifier of a node providing a type of service for a geospatial region according to another aspect of the subject matter described herein;

FIG. 3A is a block diagram illustrating the components of FIG. 2 as a system library accessible by applications and other executables in an execution environment;

FIG. 3B is a block diagram illustrating the components of FIG. 2 as subcomponents of an application;

FIG. 3C is a block diagram illustrating the components of FIG. 2 as components of a server hosting both a resource provider and a map service;

FIG. 4A is a block diagram illustrating a network having a node including an execution environment for hosting an arrangement of components corresponding to the components of FIG. 2 communicating with a network directory service according to an aspect of the subject matter described herein;

FIG. 4B illustrating a node including an execution environment for hosting an arrangement of components corresponding to the components of FIG. 2 communicating with a network directory service via a border node according to an aspect of the subject matter described herein;

FIG. 4C illustrating a node including an execution environment for hosting an arrangement of components corresponding to the components of FIG. 2 communicating with a network directory service via a multicast server node according to an aspect of the subject matter described herein;

FIG. 5 is a block diagram illustrating a map used in a browser for determining network identifiers of one or more services of a specified type for a geospatial region according to an aspect of the subject matter described herein;

FIG. 6 is a flow diagram illustrating a method for identifying a node providing a type of service for a geospatial region according to another aspect of the subject matter described herein;

FIG. 7 is a block diagram illustrating components for identifying a node providing a type of service for a geospatial region according to another aspect of the subject matter described herein;

FIG. 8A is a block diagram illustrating the components of FIG. 7 as components included in a network directory system (NDS) server according to an aspect of the subject matter described herein; and

FIG. 8B is a block diagram illustrating the components of FIG. 7 as components included in a NDS server based on the capabilities of a multicast service.

### DETAILED DESCRIPTION

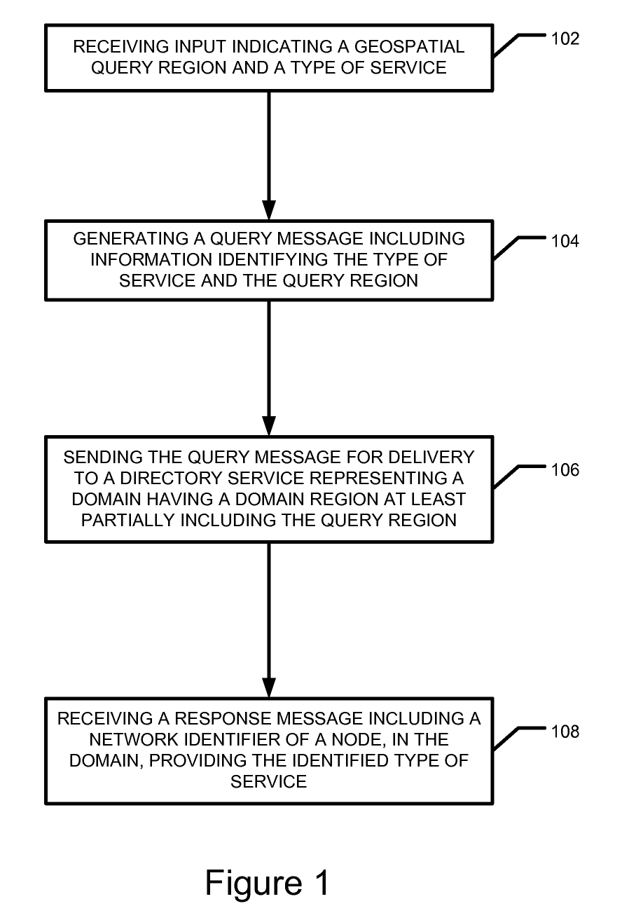

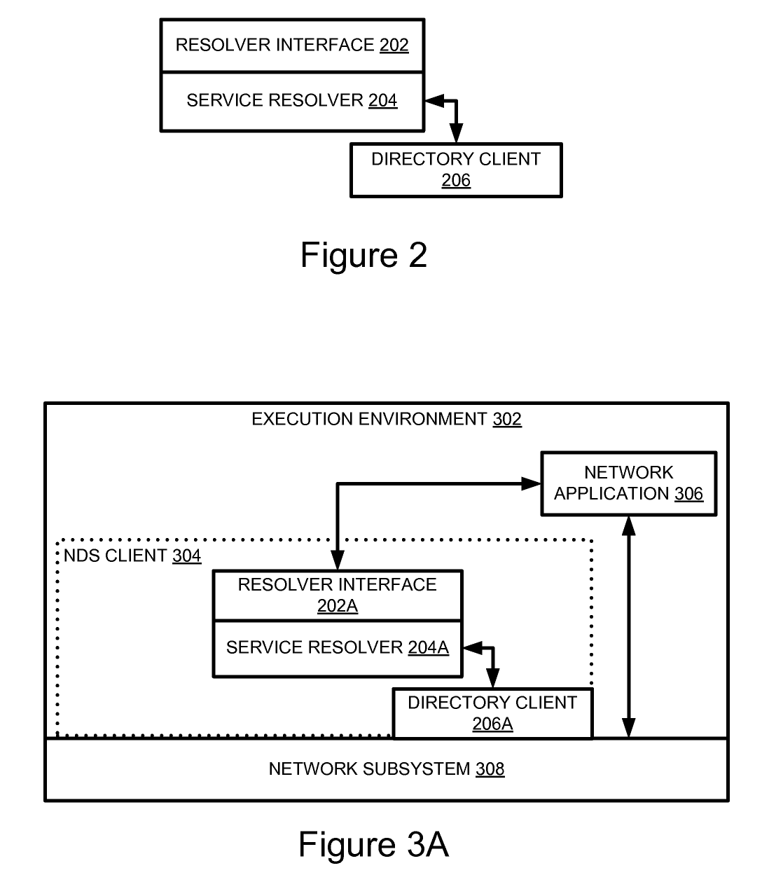

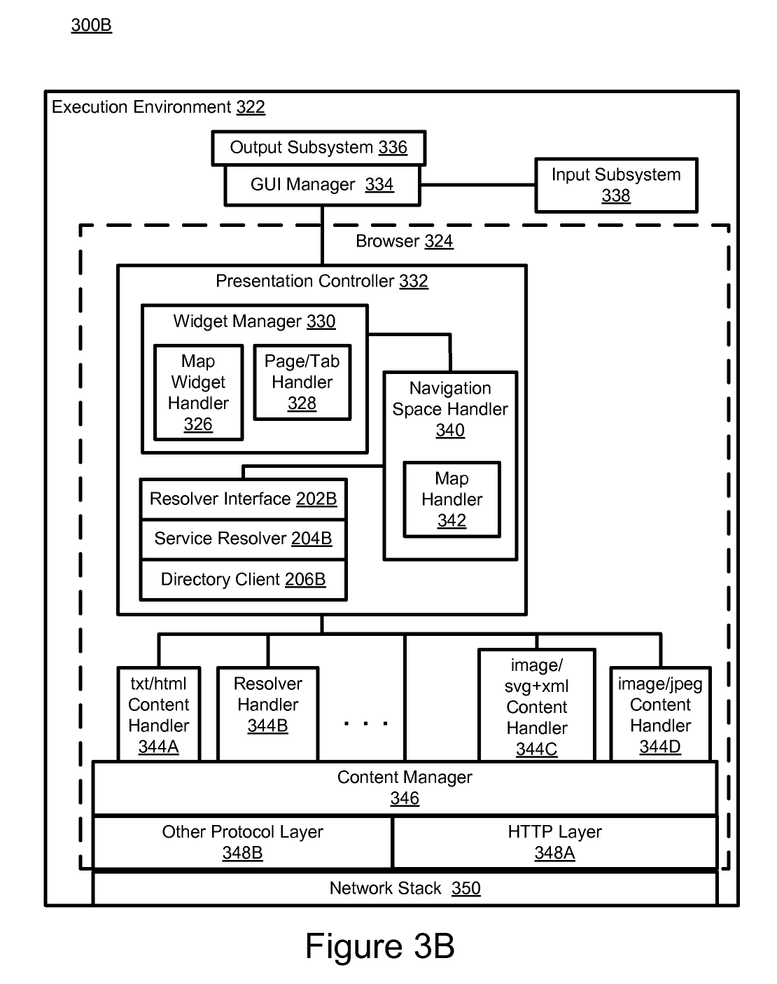

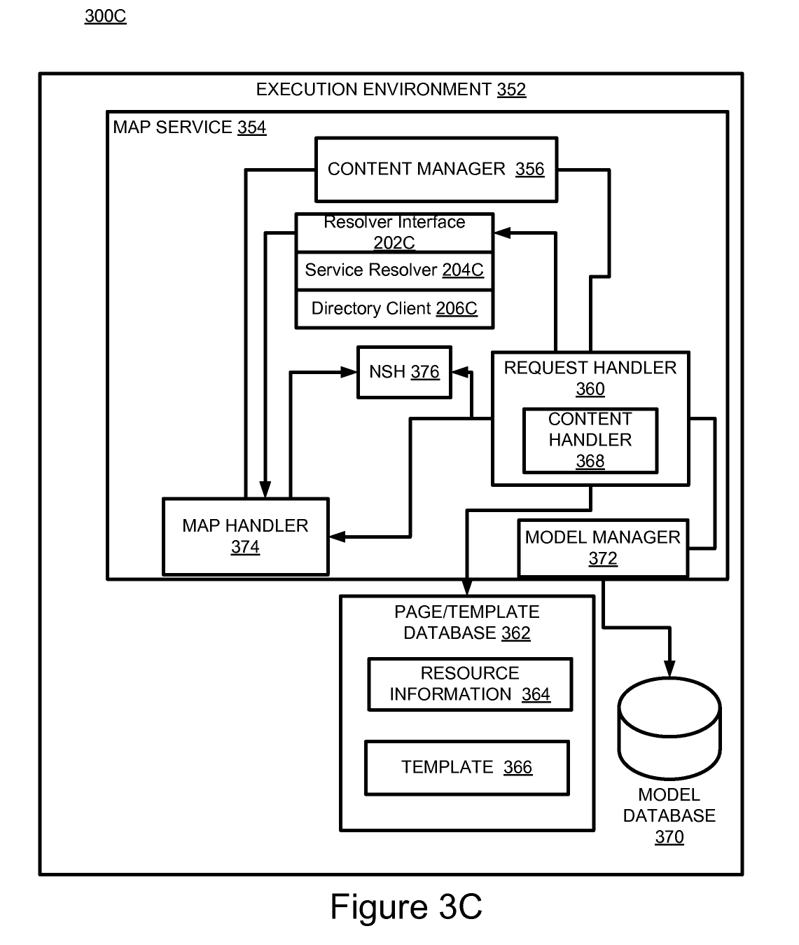

FIG. 1 is a flow diagram illustrating a method for determining a network identifier of a node providing a type of service for a geospatial region according to an exemplary aspect of the subject matter described herein. FIG. 2 is a block diagram illustrating components of a system for determining a network identifier of a node providing a type of service for a geospatial region according to another exemplary aspect of the subject matter described herein. FIG. 3 is a block diagram illustrating an arrangement of components providing an execution environment configured to host the arrangement of components illustrated in FIG. 2. The method in FIG. 1 can be carried out by, for example, some or all of the components illustrated in the exemplary arrangement in FIG. 2 operating in an a compatible execution environment, such as the environment provided by some or all of the components of the arrangement in FIG. 3.

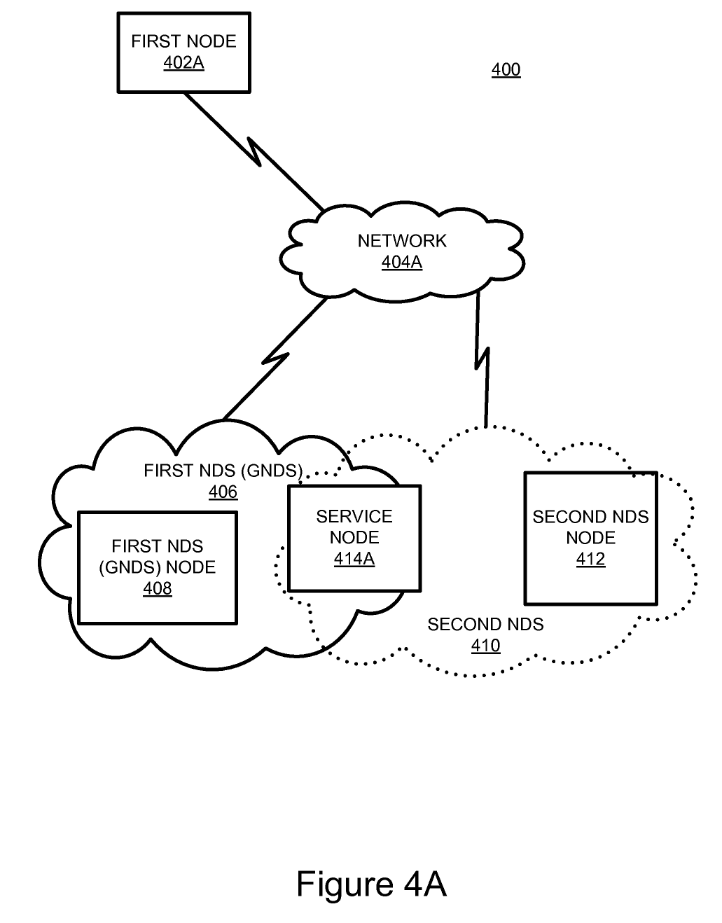

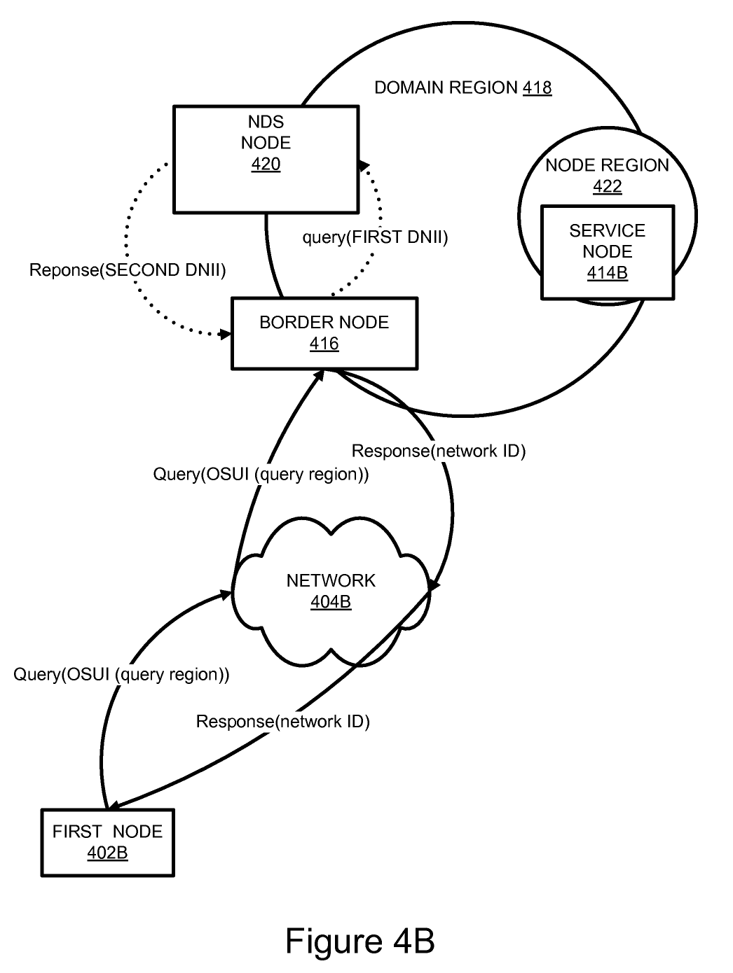

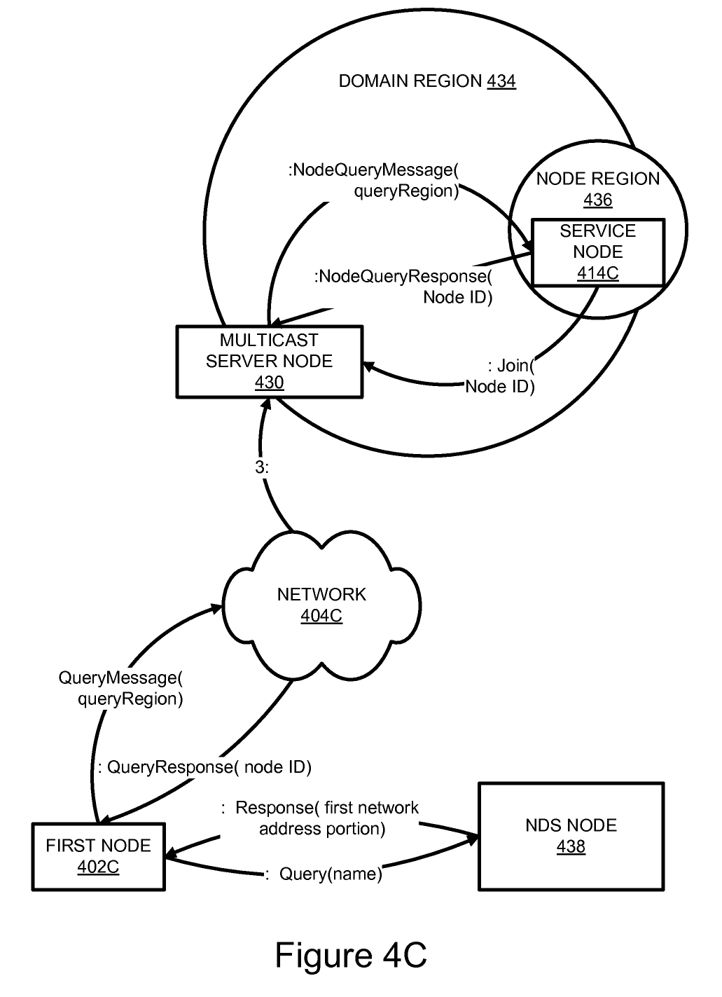

An execution environment can be hosted by a node and/or can be hosted by multiple nodes as in a distributed execution environment. In FIG. 4, a first node 402A can be configured to provide the execution environment 302 adapted to support the operation of the components in FIG. 2 in performing the method illustrated in FIG. 1. An exemplary execution environment includes a computer readable media, such as a memory, for storing components and an instruction processing component, such as processor and/or a digital signal processor (DSP), for electronically processing instructions and any data included in and/or associated with the operation of the components such as the components in FIG. 2. The components in FIG. 2 and functionally analogous arrangements of components each can require additional hardware and/or software subsystems according to their particular operational requirements. For example, a network subsystem can be included in the execution environment 302 to communicate with a component in a remote device, such as a second node over a network 406 as will be described. An operating system, persistent data storage subsystem, memory management subsystem, and/or a process scheduler are other examples of components that can be required for various adaptations of the components in FIG. 2 and its functional analogs for performing the method in FIG. 1.

A network directory system (NDS) representing a domain space of network identifiers can be configured to resolve a first network identifier in a first domain space, such as a network name in a network name identifier domain space, to a second network identifier in a second domain space, such as a network address in a network address identifier domain space or vice versa, in response to a request from a client, such as an application operating in an execution environment provided by a node. The domain name system (DNS) provides multiple DNS servers hosted by multiple nodes each representing one or more domains in a naming domain space and/or a network address domain space. The DNS is a NDS for resolving names from a name domain space to corresponding network addresses in an address domain space and vice versa. The term NDS service, as used herein, can refer to at least one NDS server, at least one NDS node hosting the referred to NDS server(s), and a NDS including the referred to NDS server(s).

A domain in a domain space can have a geospatial region associated with the domain, referred to herein as a domain region. The association between a domain and a domain region can be based on a relationship between the domain region and the domain. The relationship can be of any type, can be unidirectional or bidirectional, and can have cardinality. For example, the relationship associating a domain with a domain region can be of a type based on at least one of an owner, a user, an administrator, a purchase of, a legal right associated with, a node in, an authentication service for, an authorization service for, a signer of a digital certificate for, and an identifier of one or more of the domain, a node in the domain, and the domain region.

Analogously, a node can have a geospatial region associated with the node, referred to herein as a node region. The association between a node and a node region can be based on a relationship between the node region and the node. The relationship can be of any type, can be unidirectional or bidirectional, and can have cardinality. For example, the relationship associating a node with a node region can be of a type based on at least one of an owner, a user, an administrator, a domain and/or domain region including, a purchase of, a legal right associated with, an authentication service for, an authorization service for, a signer of a digital certificate for, and an identifier of one or more of the node and the node region.

A network identifier is an identifier for a communication endpoint on a network. An Internet Protocol (IP) address is a network identifier for communicating over an IP network such as the Internet. A network identifier in the role of an address in a network protocol is referred to as a network address. The DNS includes a set of names that include network identifiers. The DNS is configured to map a DNS name to a network address. A network identifier that references or resolves to a network address with respect to a network protocol is referred to as a symbolic identifier and/or a network name in this document. A network identifier can be at least one of a network address and a symbolic identifier of a network address, such as a DNS name. A network address is a network layer address identifying a network interface (e.g. unicast) or a set of interfaces (e.g. multicast or broadcast).

A network identifier includes a node portion identifying a network interface of a node in an identifiable portion of a network. A network identifier includes a domain portion identifying the portion of the network including the network interface identified by the node portion. A node portion and/or a domain portion can be included in a network identifier explicitly or implicitly. A scoped network identifier, for example, includes an implicit domain and/or node portion determined based on a portion of a network including a node processing the scoped network identifier. A network address, such as an Internet Protocol (IP) address, includes, explicitly and/or implicitly, a domain portion referred to as a subnet ID. For example, the IP address, 162.195.20.0, identifies a subnet including nodes with network addresses that begin with the IP address prefix 162.195.20. To more precisely identify a subnet an IP address or a portion of an IP address can be associated with a mask, such as 255.255.255.0, the mask can identify the subnet portion of an IP address via a logical “or” operation performed between each pair of bits identified by bit position in an IP address and the mask.

Analogously, a network name identifying a node, such as a DNS name, can includes, explicitly and/or implicitly, a portion identifying a domain and optionally subdomains each identifying a portion of a network, such as the Internet. For example, “nc.sceneralabs.com”, can identify a naming domain where a network interface of a node in the naming domain is associated with a name such as, “placid”. The name “placid” serves as a node portion identifying a network interface of the node within the naming domain, “nc.sceneralabs.com”. The complete network name, “placid.nc.sceneralabs.com”, identifies the node when used anywhere within any domain in the naming domain space.

As discussed above, a network identifier includes a node portion that identifies a network interface of a node in a portion of a network identified by a domain portion of the network identifier. For example, in an IP address, a portion of the address can be associated with a particular network interface in an identified subnet, thus identifying the network interface of the node. In the IP address 162.195.20.143 in the subnet 162.195.20.0/255.255.255.0, 143 is a node portion identifying a network interface of a node in the subnet identified by the domain portion 162.195.20. A subnet is a domain in a network address domain space. In a DNS name the first portion of the name identifies a network interface of a node in an identifiable domain. As identified, “placid” is a node portion identifying a network interface of a node in a naming domain identified by “nc.sceneralabs.com”, and “placid.nc” is a node portion in a parent naming domain identified by a domain portion, “sceneralabs.com”.

With reference to FIG. 1, in block 102 input indicating a geospatial query region and a type of service is received. Accordingly, a system for determining a network identifier of a node providing a type of service for a geospatial region includes means for receiving input indicating a geospatial query region and a type of service. For example, as illustrated in FIG. 2, a resolver interface component 202 is configured to receive input indicating a geospatial query region and a type of service. The input can be received from a user, from an application, from a hardware component, via an audio input device, etc.

The resolver interface component 202 can provide an API (application program interface) to receive input indicating a geospatial query region and a type of service from one or more other components, and/or can provide a GUI (graphical user interface) component for receiving input indicating a geospatial query region and a type of service from a user according to a configuration of a resolver interface component.

The indicated query region can be specified as one or more geospatial addresses, for example formatted as coordinates, from any number of geospatial address spaces including various coordinate systems (e.g., Cartesian, GPS (global positioning system), postal addresses, and the like). For example, the query region can be specified using global positioning system (GPS) coordinates identifying a geographic location/region. The terms “location” and “region” are used interchangeably in this document. The GPS coordinates can include at least one of a latitude coordinate, a longitude coordinate, and an altitude coordinate. Alternatively or additionally, the query region can specify a portion of a street address, thereby identifying a geographic location/region.

The query region can be specified with a geospatial identifier. A geospatial identifier includes any identifier that includes a portion usable for identifying a location in a geospatial region. A domain space of geospatial identifiers is referred to herein as a geospatial domain space. Examples of geospatial identifiers include:

postal://usa.nc.cary.corning-road:111.suite:220.placid

postal://placid.suite:220.corning_road:111.cary.nc.usa

postal://placid.suite:220:corning_road:111.27518.

Each of the above examples is from a geospatial domain space based on the US Post Office domain space including postal addresses.

The table below provides examples of three geospatial identifiers each from a different geospatial domain space specifying the same region, region A, on the Earth. The first geospatial identifier is from the World Geographic System (WGS) geospatial domain space. The second geospatial identifier is from the commonly known latitude/longitude geospatial domain space for identifying Earth regions. Each of the latitude and longitude coordinates can be expressed in degrees, minutes, and/or seconds. The third geospatial identifier is from the Global Positioning System (GPS) geospatial domain space.

| | WGS | | Deg/Min/Sec | | GPS | |
|---|---|---|---|---|---|---|
| Region | Latitude | Longitude | Latitude | Longitude | Latitude | Longitude |
| Region A | 30.29128 | −97.73858 | 30° 17′ 28″ | −97° 44′ 18″ | N30 17.477 | W97 44.315 |

Geospatial identifiers can be defined for specifying regions/locations having a variety of shapes including a rectangle, a circle, an oval, or any shape including a closed region. A geospatial identifier can identify a region with disjoint sub-regions; for example, by including a geospatial attribute that identifies the sub-regions. The identifier, “40+”, from an address space identifying average annual rainfall totals over a specified period identifies a geospatial region including all sub-regions that have an average annual rainfall over 40 inches.

A reference or alias for a geospatial coordinate system can be used that can be translated to a coordinate based indicator (e.g. region A). A geospatial region can be specified using meteorological data, population data, topographical data, political data, or any data that identifies a region. As described above, a region can be disjoint including multiple non-contiguous regions. For example, the region where births per 1000 women per year exceed 20 can identify a query region made up of more than one disjoint sub-region.

A service type can be indicated in any number of ways. For example, a service type can be specified via a protocol identifier (SMTP, HTTP, FTP, etc), or a port number (port 80 for HTTP, port 443 for HTTPS, port 21 for FTP, etc.). A service can be specified by resource type. “text/html”, for example, is a MIME type specification for identifying a web service (HTTP and/or HTTPS). More broadly a service type can be identified by a category of service performed or available. Examples include print, photo-sharing, retail, hardware, government, school, etc.

The components of FIG. 2 can be adapted to operate in any number of execution environments. An execution environment can be provided by a single node or distributed across more than one node. A node is any device operatively coupled to a network such as the Internet. For example, a device including an Ethernet network interface card (NIC) and/or a wireless adapter can be a node. FIGS. 3A-3C illustrate adaptations of the components of FIG. 2 adapted to operate in each of the three execution environments.

FIG. 3A illustrates the components of FIG. 2 adapted to operate in an execution environment 302 including an NDS client 304 including a resolver interface component 202A configured to receive input indicating a geospatial query region and a service type from other components, such as a network application 306, to locate a network identifier of a network interface of a node providing the type of service associated with the query region. The execution environment 302 can be provided by a first node 402 illustrated as adapted for operation in various network environments described in more detail below as a first node 402A in FIG. 4A, a first node 402B in FIG. 4B, and a first node 402C in FIG. 4C.

A node providing the execution environment 302 can be client node of a user, a server node, a proxy node, and the like. Proxy nodes include border nodes, multicast server nodes, and NDS servers that don't represent a domain that includes at least a portion of the query region.

Multiple applications and components can take advantage of the method performed by the components of FIG. 2 when adapted for operation in an application and/or component such as the NDS client 304. The NDS client 304 can provide access to one or more network directory services such as provided by the DNS, a geospatial NDS, an LDAP (lightweight directory access protocol) directory service, a NDS accessed via a border node, and/or a multicast service providing access to a network directory service as described below. Applications, such as the application 306, and other components operating within the execution environment 302 can identify a query region and a service type to the NDS client 304 via the resolver interface component 202A.

A border node is a node having an outside network interface for receiving, via a network path outside the scope of an identified domain, a packet addressed with an outside-scope unicast address. The border node can be configured to provide for processing a message, such as a packet, sent from a node with a network interface outside the domain identified by the outside-scope address. An outside network interface has a network link to a network interface of a node outside the identified domain. The border node has an inside network interface. The inside network interface of the border node can be included in the specified domain. The inside network interface is included in a network path including a network interface in the specified domain. Further details about border node operation may be found in U.S. patent application Ser. No. 12/170,821.

FIG. 3B illustrates an execution environment 322 that includes a browser component 324 with network browsing capabilities. The execution environment 302 can be provided by a first node 402 illustrated as adapted for operation in various network environments described in more detail below as a first node 402A in FIG. 4A, a first node 402B in FIG. 4B, and a first node 402C in FIG. 4C.

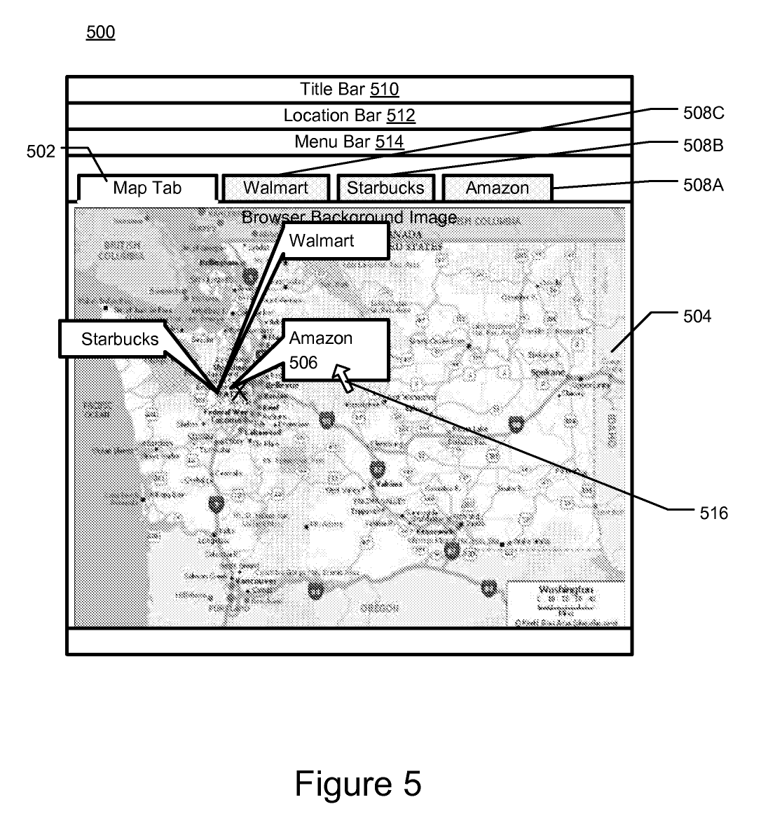

The browser component 324 includes the components of FIG. 2 adapted to operate in the browser component 324 to adapt the browser component 324 to determine a network identifier of a service(s) of a specified type in a particular geospatial region, the query region. A browser can provide a text based and/or form based interface to a user for receiving input indicating a type of service and a query region. As illustrated in FIG. 3B, the browser component 324 can additionally or alternatively include a map widget handler component 326 configured to present a map widget, such as a map tab widget 502 illustrated in FIG. 5. The map tab widget 502 provides a presentation space for presenting a map 504 by the map widget handler component 326. The map 504 and map tab widget 502 are presented along with other browser user interface widgets illustrated in FIG. 5 including flyover widgets such as an “Amazon” flyover widget 506 corresponding to an open “Amazon” tab widget 508A. A “Starbucks” flyover widget and a “Walmart” flyover widget are also illustrated and correspond to an open “Starbucks” tab widget 508B and an open “Walmart” tab widget 508C, respectively.

FIG. 5 also illustrates other browser widgets including a title bar widget 510, a location bar widget 512, and a menu bar widget 514. Each widget is presented by a widget handler component such as a page/tab widget handler component 328. Widget handlers are managed by a widget manager component 330 that can be provided to manage instantiation, deletion, and communication among various widget handlers. The widget manager component 330 is included in a presentation controller component 332 of the browser component 324, as illustrated in FIG. 3B. The presentation controller component 332 can be configured to instruct a GUI manager component 334 to draw the various widgets of the browser UI into one or more data buffers of a presentation device such as a display device (not shown) managed by an output subsystem component 336 of the execution environment 322.

The execution environment 322 can include an input subsystem component 338 configured to interoperate with one or more input devices such as a pointing device (mouse) and/or a keyboard for receiving input from a user. Input can be received for example, via an input associated with a mouse pointer 516 for selecting an identified service type, such as “retail”. A query region can be identified by selecting a region of the map 504 via the mouse pointer 516 and/or by entering geospatial information via, for example, the location bar 512. The query region can be in a visible portion of a map and/or a non-visible portion of the map. A query region can be identified automatically based on the presentation of a map. For example, a tab widget can be activated based on a URL entered via the location bar 514, selected as a link in another tab, selected as a bookmark, or in any number of other ways. The presenting of a resource of a service provider in a tab widget 504 can result in a map in the map tab 502 being changed, resized, or otherwise modified so that a location associated with the service provider resource presented in the tab can be represented on the map. Alternatively, the resource presented in the map can affect the query region based on an input from the user after the resource is presented, such as an input for adding a mark on a map corresponding to the service provider of the resource.

In FIG. 3B, input can be received via an input subsystem component 338, and provided to the GUI manager component 334 where the GUI manager component 334 can be configured to associate the input with a location/region on the display, for example, based on a position of the mouse pointer 516. The GUI manager component 334 can determine a widget that corresponds to the location on the display. The GUI manage component 334 identifies a widget handler component for processing the input based on the determined widget. The GUI manager component 334 can interoperate with the widget manager component 330 to identify the appropriate widget handler component. Region information either from the location bar 512 or other control of the browser component 324 can be provided to a navigation space handler component 340 for processing. Input identifying a region such as a query region can be received in association with the map 504 and is thus provided to the map widget handler component 326 for translating the position on the map into region information compatible with the navigation space handler component 340. For example, a mouse click can be received in correspondence with a pointer over a region of a presented map.

A navigation space handler component 340 can be configured to translate map region information via a map handler component 342 to geospatial region information recognizable by a network directory service. The navigation space handler component 340 can be configured to provide information identifying a query region and a service type to the resolver interface component 202B.

A service type and/or a query region can be received via user input, an audio input device, identified by a task being performed, identified by a resource being presented, associated with a map and/or the identified region. For example, the query region and/or service type can be included in a bookmark, browsing history, etc. of, for example, a browser, that is received as input. The query region and/or the service type can be determined based upon a specific time period in which the query region and/or the service type were previously identified. For example, the query region and/or the service type can be based upon a current time of day, a day of the week, and/or can be based on information associated with a past time period. The examples provided intended to be instructive and not exhaustive.

FIG. 3C illustrates an execution environment 352 provided by a node for hosting a map service component 354 configured to provide maps to clients such as the browser component 324. The map service component 354 can operate independently of or be integrated with a service having a particular type, such as a web service. The map service component 354, as illustrated, includes a content manager component 356 configured to receive requests and send responses and/or asynchronous messages to clients and/or other remote services. The content manager component 356 can be configured to route requests, for example, based on a command included in the request, a path, and/or a request type; to a request handler component 360 for processing the particular request. A request can include a query region and a service type identifier and/or can be a request where a request handler component 360 can identify a query region and/or service type. For example, region information can be included in a page/template database component 362 in one or more resource information records (and/or files) 364 or one or more resource templates 366. Response information can be assembled and generated by one or more content handler components 368 included in and/or operatively coupled to the request handler component 360. Data for filling a template 366 and/or for generating dynamic data can be retrieved from and/or generated by data from a model database component 370 accessible via a model manager component 372.

To identify one or more nodes associated with a region and a service type, a request handler component 360 can be configured to provide the region information as a query region and information identifying the service type to a resolver interface component 202C operating in the map service component 354.

Returning to FIG. 1, in block 104 a query message is generated including information identifying the type of service and the query region. Accordingly, a system for determining a network identifier of a node providing a type of service for a geospatial region includes means for generating a query message including information identifying the type of service and the query region. For example, as illustrated in FIG. 2, a service resolver component 204 is configured to generate a query message including information identifying the type of service and the query region. The service resolver component 204 can generate the query message based on the information provided by the resolver interface component 202.

In FIGS. 3A-3C the service resolver components 204A, 204B, 204C are configured to perform analogous functions but are adapted to operate in different execution environments. For example, message format, protocol, and/or data representations can vary based on the configuration of each arrangement of components. The query message can be formatted according to a publish-subscribe protocol (e.g., a query message can be a subscription, a publish, and/or a notification, etc.), a network directory access protocol (e.g., DNS protocol, lightweight directory access protocol (LDAP), etc.) and the like.

The query message can be generated by locating a record identified by the query region. The record includes a network address or a reference for locating the network address. For example, the network address can be a network address of a multicast service to which the query message can be sent where the network address is based upon the query region. Alternatively or additionally, the query message can be generated to send to a NDS that includes a NDS server operating in a node. The NDS server can be configured to maintain, for a domain identified by at least a portion of the query region, an association between at least two of a network identifier, a domain, and a domain region and/or a node region.

Returning to FIG. 1, in block 106 the query message is sent for delivery to a network directory service representing a domain having a domain region at least partially including the query region. Accordingly, a system for determining a network identifier of a node providing a type of service for a geospatial region includes means for sending the query message for delivery to a network directory service representing a domain having a domain region at least partially including the query region. For example, as illustrated in FIG. 2, a directory client component 206 is configured to send the query message for delivery to a network directory service representing a domain having a domain region at least partially including the query region.

A NDS includes a network directory server operating in an execution environment of a node and configured to represent a domain in a domain space represented by the NDS. The domain has or corresponds to a geospatial domain region (domain region, for short) as described above. A network directory service can be configured to receive and process the query based on whether the query region is at least partially included in the domain region as is described below. The directory client component 206 can be invoked by the service resolver component 204 to send the query message generated by the service resolver component 204.

A network directory service represents a domain in a domain space represented by an NDS including the network directory service. The domain has or corresponds to a domain region. A network directory service can be configured to receive and respond to the query when the query region is at least partially included in the domain region.

The query message format, application and/or transport protocol, data representations, and addressing can vary based on the configuration of an arrangement of the components in FIG. 2 adapted for operating in a particular execution environment.

In an aspect, the execution environment 302 illustrated in FIG. 3A can be provided by the first node 402A illustrated in FIG. 4A. As described in U.S. application Ser. No. 12/170,281, a directory client component 206A can be configured to format a query message according to an NDS protocol of a particular NDS, such as a first NDS 406, for delivery to a network directory service. The first NDS 406 can represent a first domain space including one or more domains having respective domain regions as described above. The first NDS 406 can include one or more nodes hosting a network directory server, such as the first NDS node 408 configured to provide an execution environment hosting an NDS server of the first NDS 406. The directory client component 206A can be configured to send the query message for delivery to a network directory service by interoperating with a network subsystem component 308 to send the query message via a network 404A to the first NDS 406 for routing to a network directory service, such as the NDS server in the first NDS node 408, representing a domain having a domain region at least partially including the query region. The NDS service can be configured to maintain an association between the represented domain in the first domain space and a domain in a second domain space including a node, such as a service node 414A with a node region at least partially included in the domain region of the domain in the first domain space. U.S. patent application Ser. No. 12/170,821 describes a number of other alternatives and extensions for the operation of the directory client component 206A operating in the node 402A in network environments analogous to that illustrated in FIG. 4A. The service node 414A can have a node region at least partially included in the domain region of the domain represented by the first NDS node 408. In an aspect, at least one of the first NDS server in the NDS node 408, the second NDS server in the NDS node 412, and the first node 402A can be configured to determine whether the node region of the service node 414A partially includes the query region in addition to or instead of explicitly determining whether the domain region at least partially includes the query region.

In another aspect, the execution environment 302 can be provided by the first node 402B illustrated in FIG. 4B. A directory client component 206B can be configured to provide an outside scope destination address for sending the query message for delivery to a border node, such as a border node 416 illustrated in FIG. 4B. The border node 416 can be a border node of a domain having a domain region 418. The domain represented by the border node 416 can include one or more nodes, such as a service node 414B. The directory client component 206B can be configured to send the query message addressed with an outside scope address identifying the domain region 418 by interoperating with the network subsystem component 308 to send the query message via the network 404B to the border node 416 for routing to a NDS service, such as the NDS server in the NDS node 420, representing at least a portion of the domain having the domain region 418 at least partially including the query region of the service node 414B in the represented domain. U.S. patent application Ser. No. 12/170,829 describes a number of other alternatives and extensions for the operation of the directory client component 206B operating in the node 402B in the network environment illustrated in FIG. 4B. Further, as illustrated, the service node 414B can have a node region 422 at least partially included in the domain region 418. In an aspect, the NDS server in the NDS server node 420 can be configured to determine whether the node region 422 partially includes the query region in addition to or instead of explicitly determining whether the domain region 418 at least partially includes the query region.

In yet another aspect, the execution environment 302 can be provided by the first node 402C illustrated in FIG. 4C. A directory client component 206C can be configured to determine an address of a multicast server, for example by querying an NDS node 438 configured as a default NDS service for returning the network address of the multicast server node 430 given a network name. The network name can include geospatial information and/or can be determined based on the query region. The multicast server node 430 can be associated with a domain region 434. The domain region 434 represented by the multicast server node 430 can include one or more nodes, such as a service node 414C. The directory client component 206A can be configured to send the query message addressed with the network address of the multicast server node 430 received from the NDS node 438 identifying the domain region 434 by interoperating with the network subsystem component 308 to send the query message via the network 404C for delivery to the multicast server node 430 representing the domain region 434 at least partially including the query region and including the service node 414C. U.S. patent application Ser. No. 12/170,833 describes a number of other alternatives and extensions for the operation of the directory client component 206A operating in the node 402C in the network environment illustrated in FIG. 4C. Further, as illustrated, the service node 414C can have a node region 436 at least partially included in the domain region 434. In an aspect, at least one of the multicast service in the multicast server node 430, the service node 414C, and the first node 402C can be configured to determine whether the node region of the service node 414C partially includes the query region in addition to or instead of explicitly determining whether the domain region at least partially includes the query region.

In FIG. 3B, the directory client component 206B can be configured to send a query message via a content handler component 344 where the content handler component 344 provides support for a message format compatible with a target network directory service. Alternatively or additionally, the directory client component 206B can send the query message via a content manager component 346. The content manager component 346 can be configured to support a protocol compatible with a target network directory service allowing the directory client component 206B to be protocol independent. The content manager component 346 can be configured to select a protocol layer for sending the message. FIG. 3B illustrates an HTTP layer component 348A and an “Other” protocol layer component 348B, such as, for example, a pub-sub protocol layer. The content manager component 346 can be configured to interoperate directly with a network subsystem component 350, for example via a sockets API for sending a message via TCP and/or UDP. Those skilled in the art will see that the directory client component 206B of the components of FIG. 2 adapted for operating in the browser component 324 in the execution environment 322 can be further adapted to operate in the execution environment 322 adapted for operating in the first node 402A in the network environment illustrated in FIG. 4A, in the first node 402B in the network environment illustrated in FIG. 4B, and in the first node 402C in the network environment illustrated in FIG. 4C in a manner analogous to the operation of the directory client component 206A in the respective environments as described above.

The directory client component 206C in the execution environment 352 can be configured to operate in all of the alternative first nodes 402 in various network environments including those illustrated in FIG. 4A, FIG. 4B, and FIG. 4C in a manner similar to that described above for each respective network environment. As illustrated, the directory client component 206C can provide the query message to a map handler component 374. The map handler component 374 can invoke a navigation space handler component 376 for performing any translation of the query region information to a format compatible with an NDS. The map handler component 374 can then send the query via the communication capabilities of the content manager component 356.

FIG. 4A shows a first node 402A including an execution environment for hosting an arrangement of components corresponding to the components in FIG. 2. The first node 402A providing any of the execution environments illustrated in FIG. 3A, FIG. 3B, or FIG. 3C can send the query message via the network 404A to the first NDS 406 (e.g., a geospatial NDS) for processing. The message can be routed to an NDS service such as the first NDS server hosted by the NDS node 408 represents a domain in the domain space of the first NDS 406. The domain identifies a geospatial domain region where the query region is at least partially included in the domain region.

Alternatively, the first node 402A can send a message via the network 404A to the first NDS 406 for routing to one or more nodes of the first NDS 406 such as the NDS node 408 for identifying one or more domains or nodes in a second NDS 410 that match one or both of the query region and the service type. The first node 402A can then be configured to send one or more query messages to the second NDS 410 to complete the matching operation by one or more service providers of the second NDS 410 such as a second NDS node 412 hosting a second NDS server or simply to translate a symbolic identifier of a service node 414A identified by the first NDS 406 to a network address provided by the second NDS 410 for communicating with the service node 414A.

In a further alternative illustrated in FIG. 4B, the query message can be sent by the node 402B via the network 404B to the border node 416 representing a domain having the domain region 418 that at least partially includes the query region. The border node 416 can host or can communicate with a remotely hosted network directory service, such as the NDS node 420 representing at least a portion of the domain region 418. The NDS node 420 can identify the service node 414B having the node region 422 that is at least partially included in the query region and the service node 414B hosts a service of a type identified by the service type in the query message.

FIG. 4C illustrates a multicast server node 430 hosting a multicast service providing a network directory service for resolving the query message. A multicast service is a service for the delivery of information to a group of destinations simultaneously using the most efficient strategy to deliver the messages over each link of the network only once, creating copies only when the links to the destinations split. The service node 414C can have a node region 436 that is at least partially present in a domain region 434. The network identifier of the service node 414C can be received, for example, in a join message sent from the service node 414C to the multicast server node 430. The multicast server node 430 can represent a first domain in a first domain space. The first domain identifies the domain region 434. The NDS node 438 can identify a portion of the first network address of the multicast server node 430. The query message can be sent by the second node 402C via the network 404C to the multicast server node 430 having a doman region 434 that at least partially includes the query region. The mulitcast server node 430 can communicate with the service node 414C and identify the service node 414C that can have a node region 436 that is at least partially included in the query region and that provides a service of a type identified by the service type in the query message.

Returning to FIG. 1, in block 108 a response message is received that includes a network identifier of a node, in the domain, providing the identified type of service. Accordingly, a system for determining a network identifier of a node providing a type of service for a geospatial region includes means for receiving a response message including a network identifier of a node, in the domain, providing the identified type of service. For example, as illustrated in FIG. 2, a directory client component 206 is configured to receive a response message including a network identifier of a node, in the domain, providing the identified type of service.

The response message can include a network address and/or a node name as the network identifier. The response message can include a URI for accessing the service. The response message can include an indicator that indicates that the association of the node with the query region has been verified and/or certified. The response message can include information identifying a node region and/or a region defined by the intersection of the node region and the query region. The response message can include multiple network identifiers. Each node identified by one of the multiple network identifiers is in a domain represented by a responding network directory service and, additionally, each node can have a node region that is at least partially included in the query region identified in the query message. Each node region is thus at least partially included in a domain region of a network directory server sending a response. Each network identifier in the multiple network identifiers can identify a different node associated with the query region. The query region and a node region can be the same region.

As further described in U.S. patent application Ser. No. 12/170,821 with respect to a network environment analogous to the network environment illustrated in FIG. 4A, the response including the network identifier of the node providing the identified service can be received from the first NDS node 408 in the first NDS 406 and/or from the second NDS node 412 in the second NDS 410. As further described in U.S. patent application Ser. No. 12/170,829 with respect to a network environment analogous to the network environment illustrated in FIG. 4B, the response including the network identifier of the node providing the identified service can be received from or via the border node 416, the NDS node 420, and/or the service node 414B. As further described in U.S. patent application Ser. No. 12/170,833 with respect to a network environment analogous to the network environment illustrated in FIG. 4C, the response including the network identifier of the node providing the identified service can be received from or via the multicast server node 430, and/or the service node 414C.

The directory client component 206 can provide the network identifier(s) to the service resolver component 204. The service resolver component 204 can determine that the received network identifier(s) correspond to the generated query message. The service resolver component 204 can provide the network identifier(s) to the resolver interface component 202 with information associating the provided information to the input indication received by the resolver interface component 202. The resolver interface component 202 can be configured to receive the network identifier(s) and provide a representation of the network identifiers to another component (not shown). Each of the components 202-206 in FIG. 2 can optionally perform additional processing based on the received network identifier(s) as configured in any adaptation of the arrangement of components in FIG. 2.

For example, a representation of the service and/or the node identified in the response message can be presented. The service can be accessed via an input received in correspondence with the presentation of the representation. A second query message can be generated and sent to a second NDS to receive a second network identifier from a second address space corresponding to the node. Information based on the response can be associated with a map region representing a geospatial region that at least partially includes the node region.

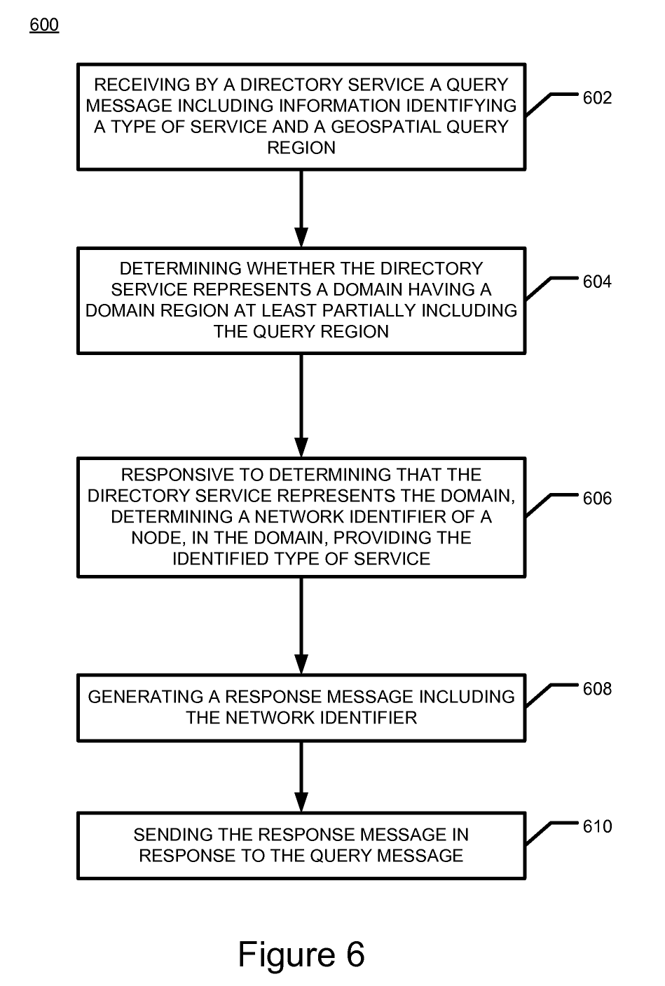

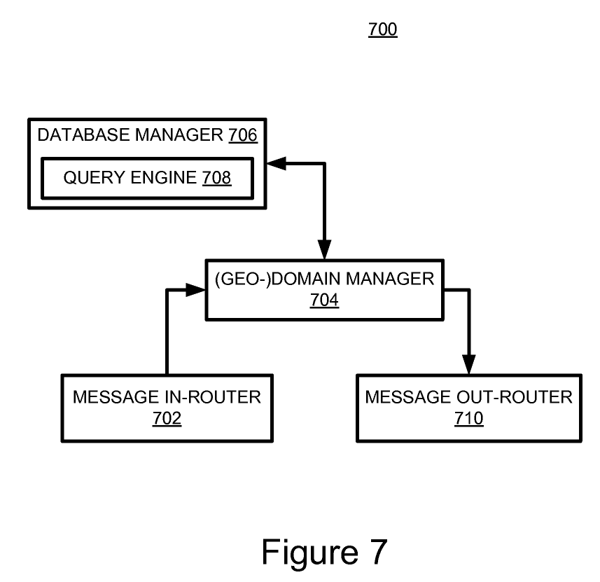

Turning now to FIG. 6, shown is a flow diagram illustrating a method for identifying a node providing a type of service for a geospatial region according to an exemplary aspect of the subject matter described herein. FIG. 7 is a block diagram illustrating a system for identifying a node providing a type of service for a geospatial region according to another exemplary aspect of the subject matter described herein. The method illustrated in FIG. 6 can be carried out by, for example, some or all of the components illustrated in the exemplary system of FIG. 7.

With reference to FIG. 6, in block 602 a query message is received by a network directory service including information identifying a type of service and a geospatial query region. Accordingly, a system for identifying a node providing a type of service for a geospatial region includes means for receiving by a network directory service a query message including information identifying a type of service and a geospatial query region. For example, as illustrated in FIG. 7, a message-in router component 702 is configured to receive by a network directory service a query message including information identifying a type of service and a geospatial query region.

The query message includes information identifying a service type and a query region. The query message can be received with a network address identifying a network interface card (NIC) of a node including the message in-router component 702. As described above, the query message can be addressed to a network directory service such as an NDS including multiple NDS servers each representing a domain in a domain space of the NDS. If the receiving NDS server does not represent a domain having a region that at least partially includes the query region, the message can be routed to another NDS server for locating a NDS service that does represent a domain having a domain region at least partially included in the query region. One can see that one or more network directory services, in a NDS, each including a message in-router component 702 can represent domains having domain regions where each domain region at least partially includes the query region.

Further as described in FIG. 4B, the query message can be received by a border node 416. The border node 416 can host a network directory service having a message in-router, described below, for receiving the query message. Alternatively or additionally, the border node 416 can route the message to a remote network directory service, such as the NDS server operating in the NDS node 420. One or more of a border node hosted network directory service and a remote network directory service can each represent a domain having a domain region that at least partially includes the query region.

As described with respect to FIG. 4C, the query message can be received by a multicast server node 430. The multicast server node 430 can host a multicast service and a network directory service having a message in-router, as described below, for receiving the query message. Alternatively or additionally, the multicast server node 430 can route the message to a remote network directory service (not shown). One or more multicast server nodes hosting network directory services and/or one or more associated remote network directory service can each represent a domain having a domain region that at least partially includes the query region.

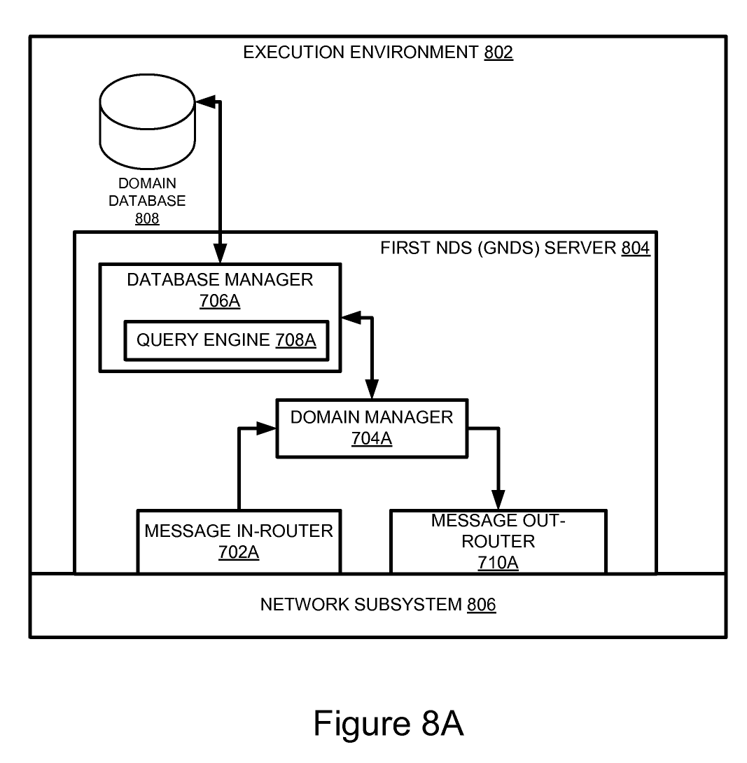

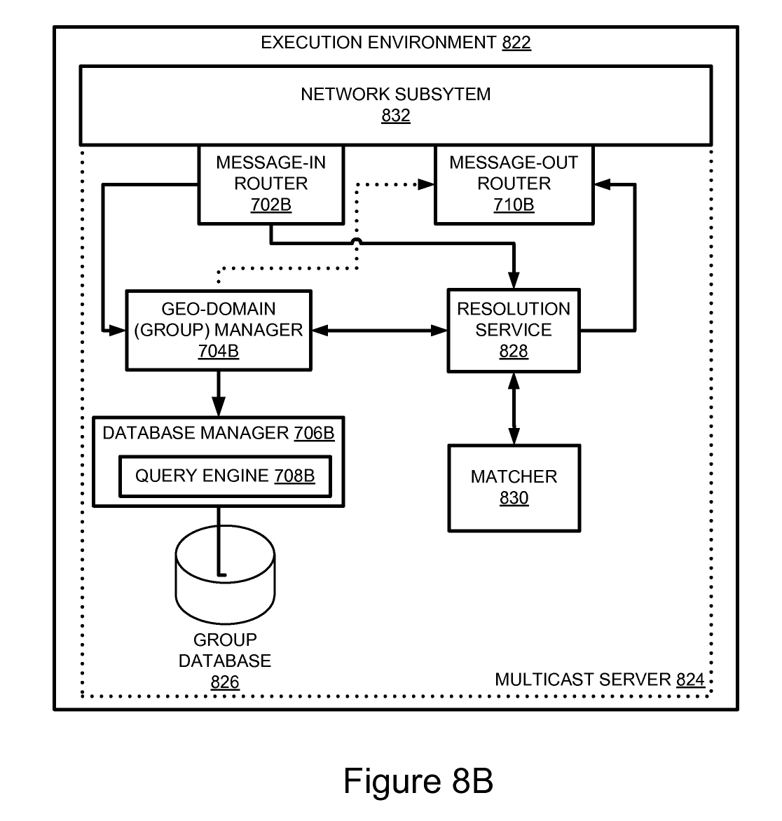

The components of FIG. 7 can be adapted to operate in any number of execution environments provided by a single node or distributed across more than one node. For example, FIG. 8A and FIG. 8B illustrate adaptations of the components of FIG. 7 adapted to operate in two different execution environments.

FIG. 8A illustrates the components of FIG. 7 configured to operate in an execution environment 802 as components included in a first NDS server 804. The first NDS server 804 can represent a domain in a domain space. The execution environment 802 can be provided by the first NDS node 408 as illustrated in FIG. 4A. The domain corresponds to a geospatial region referred to as a domain region. A message in-router component 702A is configured to receive a query message including information identifying a type of service and a query region. The query message can be received by the first NDS node 408 via a network such as the network 404A illustrated in FIG. 4A via a network subsystem component 806 included in the execution environment 802. The components of FIG. 7 can also be configured to operate in a similar execution environment as components included in a network directory service based on the capabilities of a border node, such as the border node 416 illustrated in FIG. 4B.

FIG. 8B illustrates the components of FIG. 7 configured to operate in an execution environment 822 as components included in a network directory service based on the capabilities of a multicast server component 824. The execution environment can be provided by a node such as the multicast server node 430 illustrated in FIG. 4C. The multicast server component 824 can represent a domain region, such as the domain region 434. The domain region can be a domain region of a domain in a domain space. A message in-router component 702B is configured to receive a query message including information identifying a type of service and a query region. The query message can be received via a network such as the network 404C illustrated in FIG. 4C via a network subsystem component 832 included in the execution environment 822. The query message can include service identifier information including a service matching expression for identifying a service associated with the query region. For example, the service matching expression can be used to match a service associated with a network identifier including a node portion of a network identifier identifying a network interface of a node, such as the service node 414C, from a plurality of nodes having network interfaces associated with the query region and/or the domain region. The service identifier information can include a service identifier that provides information about (or is) at least a portion of a network address or a symbolic network name. The name information can include a valid service name and/or a matching expression for matching a valid name.

Returning to FIG. 6, in block 604 a determination is made as to whether the network directory service represents a domain having a domain region at least partially including the query region. Accordingly, a system for identifying a node providing a type of service for a geospatial region includes means for determining whether the network directory service represents a domain having a domain region at least partially including the query region. For example, as illustrated in FIG. 7, a domain manager component 704 is configured to determine whether the network directory service represents a domain having a domain region at least partially including the query region.

The domain manager component 704 is configured to determine whether the domain region of the represented domain at least partially includes the query region. The determination can be based, for example, on a matching expression, via an intersection operation, and/or by determining that the query region has at least one point included in the domain region.

In FIG. 8A, the domain manager component 704 is adapted for operating in the first NDS server 804 as a domain manager component 704A. In FIG. 8B, the domain manager component 704 is adapted to operate as a geo-domain group manager 704B where network directory services can be provided for a multicast group of the multicast server 824.

The domain region of the domain represented by a network directory service can be assigned and stored as configuration data in, for example a domain database component 808 in FIG. 8A or a multicast group data base component 826 in FIG. 8B or a border node data base component.

The determination can be performed by a domain manager component 704 based on retrieving domain region information and/or can be determined by a database manager database component 706. See FIGS. 8A & 8B for database managers 706A including a query engine 708A and database manager 706B including a query engine 708B, respectively, adapted for operation in each of the execution environments illustrated in the two figures. Alternatively or additionally, in FIG. 8B the message in-router component 702B can provide query info to a resolution service component 828 for determining whether the domain region at least partially includes the query region. The resolution service component 828 can invoke a matcher component 830 for performing the determination, for example, based on the format and convention by which the query region and service type are provided.

If a determination is made that the query region and the domain region have no intersection, a message can be sent for delivery to another network directory service for identifying a node associated with the query region. The address of another service can be sent to a sender of the query message for redirecting the query message. Alternatively or additionally, the network directory service making the determination can send the message for routing through an NDS including the network directory service for delivery to another network directory service. The routing can be performed, in one aspect, based on geospatial information associated with the query message. Alternatively or additionally, the address of the other service can be based on the query region.

Returning to FIG. 6, in block 606 responsive to determining that the network directory service represents the domain, a network identifier of a node, in the domain, providing the identified type of service is determined. Accordingly, a system for identifying a node providing a type of service for a geospatial region includes means for responsive to determining that the network directory service represents the domain, determining a network identifier of a node, in the domain, providing the identified type of service. For example, as illustrated in FIG. 7, a database manager component 706 is configured to, responsive to determining that the network directory service represents the domain, determine a network identifier of a node, in the domain, providing the identified type of service.

When a network directory service determines that the domain region of the domain represented by the network directory service at least partially includes the query region, the domain manager component 704 can instruct a database manager component 706 to return network identifiers of all nodes in the domain providing the identified service. Alternatively, the domain manager component 704 can instruct a database manager component 706 to process a query based on the query region and the identified service to determine one or more network identifiers of nodes in the domain that have a node region that is at least partially included in the query region and provides a service that matches the specified type.

In FIG. 8A, the query engine component 708A can be included in the database manager component 706A, and can be invoked by the domain manager component 704A to process a query generated based on query region information and service type information to search the records of the domain database 808. Any matching network identifiers are returned to the domain manager component 704A. Additionally or alternatively, the query can be based on: i) a portion of the region information and type information: ii) a portion of the region information or type information; or iii) neither of the portion of the region information and type information resulting in returning a superset of network identifiers that can match the query and service type information. The final matching process can be performed by the domain manager component 704A and/or a querying and/or other node.

In FIG. 8B, the query engine component 708B in the database manager component 706B can be called by the domain group manager component 704B to determine one or more subscribers in the group database. In one aspect, the query can be based on a portion of the query region information and/or service type information returning a superset of network identifiers that can match the query region and service type information. The final matching process can be performed by a domain resolution service component 828 using one or more matcher components 830 evaluating the matching conditions of the query region and service type information. As described, at least a portion of a matching process can be performed by a querying and/or other node. The components of FIG. 7 can also be configured to operate in a similar execution environment as components included in a border node.

Returning to FIG. 6, in block 608 a response message is generated including one or more network identifiers. Accordingly, a system for identifying a node providing a type of service for a geospatial region includes means for generating a response message including the network identifier(s). For example, as illustrated in FIG. 7, a domain manager component 704 is configured to generate a response message including the network identifier(s).

In FIG. 8A, the domain manager component 704A is configured to generate a response message including one or more network identifiers. The network identifier(s) can be returned by the database manager component 706A in processing the query via the query engine component 708A. In FIG. 8B, the response message can be generated by the domain (group) manager component 704B and/or the resolution service component 828.

The response message can include a network address and/or a network name as the network identifier. The response message can include a URI for accessing the service. The response message can include an indicator that indicates that the association of the node with the query region has been verified and/or certified. The response message can include information identifying at least one of a domain region and a node region; and/or a region defined by the intersection of the node region and the query region. The response message can include multiple network identifiers. The network identifier or each network identifier can have a corresponding node region that is at least partially included in the query region identified in the query message. Each node region is thus at least partially included in a domain region of a network directory service sending a response. Each network identifier in the multiple network identifiers can identify a different node associated with the query region. The query region and a node region can be the same region.

The response message can include a representation of the service and/or the network identified in the response for presentation. Information based on the response can be associated with a map region representing a geospatial region that at least partially includes at least one of the domain region and the node region. The information can be used for identifying and retrieving a map associated with the query region, the domain region, and/or the node region.

Returning to FIG. 6, in block 610 the response message is sent in response to the query message. Accordingly, a system for identifying a node providing a type of service for a geospatial region includes means for sending the response message in response to the query message. For example, as illustrated in FIG. 7, a message-out router component 710 is configured to send the response message in response to the query message.

The response message can be addressed to the originator of the query and/or routed back through the network directory server nodes of an NDS for sending the response to the sender of the query message. In FIG. 8A, a message-out router component 710A is configured to operate with the network subsystem component 806 for sending the response message. In FIG. 8B, the message-out router component 710B is configured to operate with network subsystem component 832 for sending the response message.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for determining a network identifier of a node providing a type of service for a geospatial region, the method comprising:
receiving input indicating a geospatial query region and a type of service;
generating a query message including information identifying the type of service and the query region;
sending the query message for delivery to a network directory service representing a domain having a domain region at least partially including the query region; and
receiving a response message including a network identifier of a node, in the domain, providing the identified type of service,
wherein at least one of the preceding actions is performed on at least one electronic hardware component.

2. The method of claim 1 wherein the input further includes a network interface name identifying at least one of a first node and a service and the response message includes a network address of at least one of the first node and a second node providing the service.

3. The method of claim 1 wherein the input is received in correspondence with a presentation of a map including a representation of a geospatial region including the query region.

4. The method of claim 1 wherein a node generating the query message has a node region included in at least a portion of the query region.

5. The method of claim 1 wherein the query message is formatted according to one of a publish subscribe protocol and a network directory access protocol.

6. The method of claim 1 wherein sending the query message includes sending the query message to a multicast service where an address of the multicast service is based on the query region.

7. The method of claim 1 wherein sending the query message includes sending the query message to one of a border node and a multicast service node.

8. The method of claim 1 wherein generating the query message includes generating a message for sending to a network directory service configured to maintain, for a domain identified by the query region, at least one of an association between a network identifier and a node region and an association between the domain identified by the query region and a second domain including a network identifier.

9. The method of claim 1 wherein receiving the response message includes receiving a network address as the network identifier.

10. The method of claim 1 wherein receiving the response message includes receiving a network name as the network identifier.

11. The method of claim 1 wherein receiving the response message includes receiving a uniform resource identifier for accessing the service.

12. The method of claim 1 wherein the node, identified by the network identifier, has a node region at least partially including the query region.

13. The method of claim 1 further comprising:
generating a second query message including information identifying at least one of the type of service and the query region; and
sending the second query message to a second network directory service to receive a second network identifier from a second address space corresponding to a node providing the identified type of service.

14. The method of claim 1 wherein the network identifier of the node is included in a plurality of network identifiers each identifying a different node associated with the query region.

15. The method of claim 1 wherein the query region is based on at least one of a Cartesian coordinate system, global position system coordinates a postal address, a zip code, and a meteorological area.

16. A method for identifying a node providing a type of service for a geospatial region, the method comprising:
receiving by a network directory service a query message including information identifying a type of service and a geospatial query region;
determining whether the network directory service represents a domain having a domain region at least partially including the query region;
responsive to determining that the network directory service represents the domain, determining a network identifier of a node, in the domain, providing the identified type of service;
generating a response message including the network identifier; and
sending the response message in response to the query message,
wherein at least one of the preceding actions is performed on at least one electronic hardware component.

17. The method of claim 16 wherein the query message includes at least one of a service identifier and a service matching expression for matching a service associated with a network identifier including a network interface identifier portion from a plurality of nodes associated with the region.

18. The method of claim 16 wherein the query message includes a destination identifier formatted as an outside-scope network identifier.

19. The method of claim 16 wherein the network directory service is accessible via a border node.

20. The method of claim 16 wherein the network directory service is provided by a multicast service.

21. The method of claim 16 wherein the query message includes a service identifier, the service identifier being at least one of at least a portion of an address and a symbolic name.

22. The method of claim 21 wherein the symbolic name includes at least one of a valid service name and a matching expression for matching with a valid service name.

23. The method of claim 16 wherein receiving by the network directory service the query message comprises receiving the query message from a browser and the identified type of service is based on a current setting.

24. The method of claim 16 further comprising in response to determining that the network directory service does not represent the domain, sending a message for delivery to another network directory service for identifying a node associated with the query region.

25. The method of claim 16 wherein an association identifying the node and the query region is associated with information indicating that the association of the node with the query region has been one of verified and certified.

26. The method of claim 16 wherein the network identifier is included in a plurality of network identifiers each identifying a different node associated with the query region.

27. The method of claim 26 wherein the query message includes a service identifier, the service identifier being at least one of at least a portion of an address and a symbolic name, the symbolic name including at least one of a valid service name and a matching expression for matching with a valid service name, the method further comprising determining whether the service identifier or the matching expression matches a node identifier portion of a network identifier included in the plurality of network identifiers.

28. The method of claim 16 wherein the node, identified by the network identifier, has a node region at least partially including the query region.

29. The method of claim 16 wherein the identified type of service is associated with at least one of a port number, a protocol scheme, metadata associated with a service, and a symbolic name.

30. The method of claim 16 wherein the query message is formatted according to one of a publish subscribe protocol and a network directory access protocol.

31. The method of claim 16 wherein the query message includes a time period for determining the query region.

32. The method of claim 16 wherein the identified type of service is determined based on a specified time period in which the at least one of the query region and the type of service were previously identified.

33. A system for determining a network identifier of a node providing a type of service for a geospatial region, the system comprising:
means for receiving input indicating a query region and a type of service
means for generating a query message including information identifying the type of service and the query region;
means for sending the query message for delivery to a network directory service representing a domain having a domain region at least partially including the query region; and
means for receiving from the network directory service a response message including a network identifier of a node in the domain providing the identified type of service,
wherein at least one of the means includes at least one hardware component.

34. A system for determining a network identifier of a node providing a type of service for a geospatial region, the system comprising system components including:
a resolver interface component configured to receive input indicating a query region and a type of service;
a service resolver component configured to generate a query message including information identifying the type of service and the query region; and
a network directory client component configured to send the query message for delivery to a network directory service representing a domain having a geospatial domain region at least partially including the query region,
the network directory client component configured to receive a response message including a network identifier of a node, in the domain, providing the identified type of service,
wherein at least one of the system components includes at least one hardware component.

35. A system for identifying a node providing a type of service for a geospatial region, the system comprising:
means for receiving by a network directory service a query message including information identifying a type of service and a geospatial query region;
means for determining whether the network directory service represents a domain having a geospatial domain region at least partially including the query region;
means for responsive to determining that the network directory service represents the domain, determining a network identifier of a node, in the domain providing the identified type of service;
means for generating a response message including the network identifier; and
means for sending the response message in response to the query message,
wherein at least one of the means includes at least one hardware component.

36. A system for identifying a node providing a type of service for a geospatial region, the system comprising system components including:
a message-in router component configured to receive by a network directory service a query message including information identifying a type of service and a geospatial query region;
a domain manager component configured to determine whether the network directory service represents a domain having a domain region at least partially including the query region;
a database manager component configured to, responsive to determining that the network directory service represents the domain, determine a network identifier of a node, in the domain, providing the identified type of service,
the domain manager component further configured to generate a response message including the network identifier; and
a message-out router component configured to send the response message in response to the query message,
wherein at least one of the system components includes at least one hardware component.

37. A computer readable medium embodying a computer program, executable by a machine, for determining a network identifier of a node providing a type of service for a geospatial region, the computer program comprising executable instructions for:
receiving input indicating a query region and a type of service;
generating a query message including information identifying the type of service and the query region;
sending the query message for receipt by a network directory service that represents a domain having a geospatial domain region at least partially including the query region; and
receiving from the network directory service a response message including a network identifier of a node, in the domain, providing the identified type of service.

38. A computer readable medium embodying a computer program, executable by a machine, for identifying a node providing a type of service for a geospatial region, the computer program comprising executable instructions for:
receiving by a network directory service a query message including information identifying a type of service and a query region;
determining whether the network directory service represents a domain having a geospatial domain region at least partially including the query region;
responsive to determining that the network directory service represents the domain, determining a network identifier of a node, in the domain, providing the identified type of service;
generating a response message including the network identifier; and
sending the response message in response to the query message.
